(19) United States
(12) Patent Application Publication
(10) Pub. No.: US 2026/0304049 A1
(43) Pub. Date: Oct. 1, 2026

(54) Method for audio processing in a hearing device to provide for a speech enhancement

(71) Applicant: SONOVA AG, Staefa (CH)

(72) Inventors: Stefan Klockgether, Hombrechtikon (CH); Philipp Kohlhauer, Uerikon (CH); Stephan Mueller, Zürich (CH)

(21) Appl. No.: 19/529,880

(22) Filed: Feb. 4, 2026

(30) Foreign Application Priority Data
Mar. 31, 2025 (EP) 25167298.6

(51) Int. Cl. H04R 25/00

(52) U.S. Cl. CPC H04R 25/507; H04R 2225/43; H04R 2430/01

(57) ABSTRACT

A method of audio processing in a hearing device to provide for speech enhancement, the hearing device configured to be worn at an ear of a user, the method comprising: receiving an input signal; and processing the input signal so as to obtain an output signal, wherein the processing comprises separating one or more speech signals from the input signal in a neural network, wherein the output signal is based on one or more of the separated speech signals, characterized by detecting, by the neural network, whether the input signal comprises an own-voice component representative of a speech of the user, wherein, when the own-voice component is detected, the input signal is processed so as to provide for an effective attenuation of the own-voice component in the output signal relative to one or more of the separated speech signals in the output signal when the own-voice component is undetected.

### RELATED APPLICATIONS

The present application claims priority to EP Patent Application No. 25167298.6, filed Mar. 31, 2025, which is hereby incorporated by reference in its entirety.

### BACKGROUND INFORMATION

Hearing devices may be used to improve the hearing capability or communication capability of a user, for instance by compensating a hearing loss of a hearing-impaired user, in which case the hearing device is commonly referred to as a hearing instrument such as a hearing aid, or hearing prosthesis. A hearing device may also be used to output sound based on an audio signal which may be communicated by a wire or wirelessly to the hearing device. A hearing device may also be used to reproduce a sound in a user's ear canal detected by an input transducer such as a microphone or a microphone array. The reproduced sound may be amplified to account for a hearing loss, such as in a hearing instrument, or may be output without accounting for a hearing loss, for instance to provide for a faithful reproduction of detected ambient sound and/or to add audio features of an augmented reality in the reproduced ambient sound, such as in a hearable. A hearing device may also provide for a situational enhancement of an acoustic scene, e.g. beamforming and/or active noise cancelling (ANC), with or without amplification of the reproduced sound. A hearing device may also be implemented as a hearing protection device, such as an earplug, configured to protect the user's hearing. Different types of hearing devices configured to be be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses. A hearing system comprising two hearing devices configured to be worn at different ears of the user is sometimes also referred to as a binaural hearing device. A hearing system may also comprise a hearing device, e.g., a single monaural hearing device or a binaural hearing device, and a user device, e.g., a smartphone and/or a smartwatch, communicatively coupled to the hearing device.

Hearing devices are often employed in conjunction with communication devices, such as smartphones or tablets, for instance when listening to sound data processed by the communication device and/or during a phone conversation operated by the communication device. More recently, communication devices have been integrated with hearing devices such that the hearing devices at least partially comprise the functionality of those communication devices. A hearing system may comprise, for instance, a hearing device and a communication device.

Hearing devices, including hearing aids and hearables, have increasingly incorporated advanced speech enhancement algorithms. Among the latest developments, deep neural networks (DNNs) have been employed to perform highly effective speech separation, significantly improving speech intelligibility by also reducing background noise perception for the user. Some examples of such DNN based algorithms are disclosed in US 2022/0093188 A1, EP 4 440 145 A1, and U.S. Pat. No. 11,877,125 B2. These technologies aim to improve speech intelligibility in challenging acoustic environments by attenuating background noise while preserving speech clarity. While initially developed for individuals with hearing impairments, recent advancements have extended their use to individuals with normal to mild hearing loss, offering enhanced communication support in noisy settings.

However, while such algorithms offer significant advantages in terms of reducing auditory distractions, they also inadvertently impact a perception of the acoustic environment by the user as less realistic or unnatural when existing background noise is blend out. For example, when background noise is eliminated to a large extent, the user may perceive the acoustic environment as if they were isolated in a bubble, disconnected from their surroundings, which may reduce user comfort. The lack of environmental context can lead to further unintended consequences, e.g., with regard to a natural speech behavior of the user. In particular, users of hearing devices employing advanced DNN based speech enhancement may unconsciously speak at lower volumes than appropriate for the given environment because they hear others'speech more clearly without the usual ambient noise cues. Such effects may hinder natural communication. Communication difficulties may particularly arise for conversation partners who do not benefit from the same speech enhancement processing or who experience different levels of noise attenuation. The diminished vocal effort of the hearing device user can make their speech less intelligible to others, increasing the cognitive load on the listener and potentially leading to misunderstandings, communication frustration, and social disengagement.

Attempts to mitigate these issues by reducing the effectiveness of speech enhancement algorithms are counterproductive, as this would compromise the primary function of the technology—enhancing speech clarity in noisy conditions. Moreover, because the effect of reduced vocal effort operates unconsciously, the hearing device user may not perceive their own speech as being too quiet, further compounding the problem. Conventional DNN-based speech enhancement algorithms further exacerbate this issue, as these systems not only reduce perceived noise but may also amplify the user's own voice in low signal-to-noise conditions, leading to even greater speech level inconsistencies.

U.S. Pat. No. 11,388,514 B2 discloses a method of operating a hearing device with an activated noise cancelling in which a measured volume of the voice of the user is compared to a desired value, and when the measured volume is lower, the hearing device takes a measure to prompt the user to speak more loudly, which may include lowering of a volume of the user's own voice in the hearing device output, reducing of the active noise cancelling, or outputting an advice to the user. However, such an analysis of the user's own voice in the audio signal being detached from the actual active noise cancelling mechanism is rather complex, can be prone to errors, and can significantly slow down the prompting of the measure to the user, which then may come too late to be realized in time and effectively put into practice by the user.

### BRIEF DESCRIPTION OF THE DRAWINGS

Reference will now be made in detail to embodiments, examples of which are illustrated in the accompanying drawings. The drawings illustrate various embodiments and are a part of the specification. The illustrated embodiments are merely examples and do not limit the scope of the disclosure. Throughout the drawings, identical or similar reference numbers designate identical or similar elements. In the drawings:

FIG. 1 schematically illustrates an exemplary hearing device;

FIG. 2 schematically illustrates an embodiment of the hearing device illustrated in FIG. 1 as a RIC hearing aid;

FIG. 3 schematically illustrates a block diagram of a conventional speech enhancement algorithms based on a neural network;

FIGS. 4, 5 schematically illustrate block diagrams of exemplary speech enhancement algorithms based on a neural network according to the present invention;

FIGS. 6, 7 illustrate exemplary functional plots associated with control parameters that may be applied by speech enhancement algorithms illustrated in FIGS. 4, 5 when providing for the speech enhancement;

FIGS. 8, 9 schematically illustrate block diagrams of further exemplary speech enhancement algorithms based on a neural network according to the present invention;

FIGS. 10-12 schematically illustrate block diagrams of exemplary neural networks that may be employed in the speech enhancement algorithms illustrated in FIGS. 4, 5, 8, and 9; and

FIG. 13 schematically illustrates an exemplary method of processing an audio signal according to principles described herein.

### DETAILED DESCRIPTION

It is a feature of the present disclosure to avoid at least one of the above-mentioned disadvantages and to propose a method of operating a hearing device including a neural network for speech enhancement which provides for an improved natural perception of the acoustic surroundings during conversations. It is another feature to balance the user's need for speech comprehension with the benefit of a remaining awareness to their acoustic surroundings in an optimized way. It is another feature to restore a natural speech behavior of the user during conversations enhanced by the neural network. It is a further feature to encourage the user to maintain an appropriate vocal effort or to adjust the vocal effort appropriately despite not perceiving naturally occurring environmental noise, e.g., during the speech of a conversation partner, which would typically elicit such an adjustment. It is yet another feature to provide for one or more of these effects at rather low processing costs and/or low complexity or implementation effort, e.g., when implementing the method in already existing neural network-based speech enhancement algorithms.

Accordingly, the present disclosure proposes a method of audio processing in a hearing device to provide for a gain adjustment, the method comprising receiving an input signal from an audio input unit; and processing the input signal so as to obtain an output signal for an audio output unit configured to output the output signal. The audio signal processing comprises
separating one or more speech signals from the input signal in a neural network, wherein the output signal is based on one or more of the separated speech signals; and
detecting, by the neural network, whether the input signal comprises an own-voice component representative of a speech of the user, wherein, when the own-voice component is detected, the input signal is processed so as to provide for an effective attenuation of the own-voice component in the output signal relative to one or more of the separated speech signals in the output signal when the own-voice component is undetected.

Independently, the present disclosure proposes a non-transitory computer-readable medium storing instructions that, when executed by a processor, which may be included in a hearing device, cause a hearing device to perform the method.

Independently, the present disclosure proposes a hearing device configured to be worn at an ear of a user, the hearing device comprising an audio input unit for obtaining an input signal; a processor for audio signal processing of the input signal to obtain an output signal, wherein the processor is configured to perform the method; and an audio output unit for outputting the output signal so as to stimulate the user's hearing.

Subsequently, additional features of some implementations of the method and/or the hearing device and/or the computer readable medium are described. Each of those features can be provided solely or in combination with at least another feature. The features can be correspondingly provided in some implementations of the method and/or the hearing device and/or the computer readable medium.

In particular, the detecting of whether the input signal comprises an own-voice component by the neural network can be beneficial to provide for a fast and reliable detection of the own-voice component in the separated speech, since the neural network also provides for the speech separation. In this way, a desired naturalness of the sound presented to the user may be quickly restored during a speech of the user and/or incentives to make the user speak louder can be provided rather fast and reliable as compared to methods which would rely on a detection of the own-voice component in the input signal which is performed separately and/or detached from the speech enhancement operations performed by the neural network.

In some implementations, the providing for the effective attenuation comprises reducing an intelligibility of the own-voice component in the output signal when the own-voice component is detected as compared to an intelligibility of the one or more speech signals in the output signal when the own-voice component is undetected. In some examples, the reduced intelligibility may be measurable and/or verifiable in a perceptive model of speech comprehension.

In some implementations, the own-voice component is detected by the neural network by separating the own-voice component from the input audio signal so as to provide at least one separated speech signal representative of the own-voice component. In some examples, the one or more separated speech signals may comprise the separated speech signal representative of the own-voice component, e.g., representative of the speech of the user, and/or one or more separated speech signals representative of a speech of one or more speakers different from the user.

In some implementations, the own-voice component is detected by the neural network by classifying the one or more of the separated speech signals with regard to a likelihood that the own-voice component is contained, or not contained, in the separated speech signal.

In some implementations, the method further comprises providing the neural network with an embedding derived from a speech sample of the user representative of the user's own-voice.

In some implementations, the providing for the effective attenuation comprises one or more of reducing, when the own-voice component is detected, an amplification of the own-voice component in the output signal relative to an amplification of one or more separated speech signals in the output signal when the own-voice component is undetected; and/or increasing, when the own-voice component is detected, noise in the output signal as compared to when the own-voice component is undetected; and/or providing, when the own-voice component is detected, the output signal based in the input signal, wherein the one or more separated speech signals are excluded from the output signal; and/or activating and/or increasing, when the own-voice component is detected, an active noise cancelling in the output signal.

In some examples, increasing the noise in the output signal comprises providing the output signal based on the unprocessed input signal. In some examples, when the one or more separated speech signals are excluded from the output signal, the separated speech signals comprise a separated speech signal representative of the own-voice component. In some examples, reducing the amplification of the own-voice component in the output signal when the own-voice component is detected comprises lowering a gain applied on one or more of the separated speech signals as compared to the gain applied when the own-voice component is undetected. In some examples, the active noise cancelling is activated and/or increased for attenuating the own-voice component contained in direct sound below a transparency of the direct sound.

In some implementations, the method further comprises
determining a speech enhancement gain representative of a gain to be applied on one or more of the separated speech signals when the own-voice component is undetected; and
determining an own-voice gain representative of a gain to be applied on the own-voice component when the own-voice component is detected;
and/or the method further comprises providing a denoised signal based on one or more of the separated speech signals; and providing a noisy signal representative of a signal in which noise contained in the input audio signal is preserved to a larger extent than in the denoised signal, wherein the denoised signal and the noisy signal are mixed in accordance with a mixing ratio defining a ratio of the denoised signal relative to the noisy signal in the output signal, wherein the method further comprises
determining a speech enhancement mixing ratio representative of the mixing ratio to be applied when the own-voice component is undetected; and
determining an own-voice mixing ratio representative of the mixing ratio to be applied when the own-voice component is detected; and/or wherein the method further comprises
determining a speech enhancement noise gain representative of a gain to be applied on the noisy signal when the own-voice component is undetected; and
determining an own-voice noise gain representative of a gain to be applied on the noisy signal when the own-voice component is detected.

In some implementations, when the speech enhancement gain is determined to be increased, the own-voice gain is determined to be decreased and/or the own-voice mixing ratio is determined to be decreased and/or the own-voice noise gain is determined to be increased. In some implementations, when the speech enhancement mixing ratio is determined to be increased, the own-voice gain is determined to be decreased and/or the own-voice mixing ratio is determined to be decreased and/or the own-voice noise gain is determined to be increased. In some implementations, when the speech enhancement noise gain is determined to be decreased, the own-voice gain is determined to be decreased and/or the own-voice mixing ratio is determined to be decreased and/or the own-voice noise gain is determined to be increased.

In some implementations, at least when the own-voice component is undetected, the denoised signal is included in the output signal, and, at least when the own-voice component is detected, the noisy signal is included in the output signal.

In some implementations, the method further comprises applying, when the own-voice component is undetected, the speech enhancement gain on one or more of the separated speech signals, and, when the own-voice component is detected, the own-voice gain on the own-voice component. In some implementations, the method further comprises applying, when the own-voice component is undetected, the speech enhancement noise gain on the noisy signal and, when the own-voice component is detected, the own-voice noise gain on the noisy signal.

In some implementations, the own-voice gain is determined based on one or more of the speech enhancement gain; and/or the speech enhancement mixing ratio; and/or the speech enhancement noise gain; and/or one or more properties of the own-voice component; and/or one or more signal properties of the input signal. In some implementations, the own-voice mixing ratio is determined based on one or more of the speech enhancement mixing ratio; and/or the speech enhancement gain; and/or the speech enhancement noise gain; and/or one or more properties of the own-voice component; and/or one or more signal properties of the input signal. In some implementations, the own-voice noise gain is determined based on one or more of the speech enhancement noise gain; and/or the speech enhancement gain; and/or the speech enhancement mixing ratio; and/or one or more properties of the own-voice component; and/or one or more signal properties of the input signal.

In some implementations, the properties of the own-voice component comprise one or more of a signal level, e.g. indicative of a sound pressure level, and/or a signal level change and/or a frequency and/or a frequency shift and/or a pitch and/or a timbre and/or a loudness of the own-voice component. In some implementations, the properties of the input signal comprise one or more of a signal-to-noise ratio and/or a signal level, e.g. indicative of a sound pressure level, and/or a noise floor and/or a low frequency level of the input signal.

In some implementations, one or more of the own-voice gain; and/or the own-voice mixing ratio; and/or the own-voice noise gain are determined by a model. The model may be configured to receive input data comprising one or more of the speech enhancement gain; and/or the speech enhancement mixing ratio; and/or the speech enhancement noise gain and/or one or more properties of the own-voice component; and/or one or more signal properties of the input signal. In some implementations, the model is a machine learning algorithm.

In some implementations, when the own-voice component is detected, the denoised signal is excluded from the output signal. In some implementations, when the own-voice component is detected, the output signal is based on the noisy signal and/or the input signal, e.g., the unprocessed input signal.

In some implementations, the denoised signal is provided at a first signal path comprising the neural network, and the noisy signal is provided at a second signal path bypassing the first signal path, wherein the input signal is input into the first and second signal path.

In some implementations, the noisy signal is based on a residual signal output by the neural network, the residual signal representative of an audio signal from which the one or more speech signals are separated by the neural network.

In some implementations, the audio signal processing further comprises providing for active noise cancelling in the output signal, wherein the active noise cancelling can be activated and/or increased, e.g., a strength of the active noise cancelling can be increased, when the own-voice component is detected. In some implementations, the active noise cancelling can be deactivated and/or decreased, e.g., a strength of the active noise cancelling may be decreased, when the own-voice component is undetected.

In some implementations, when the own-voice component is detected, the own-voice component is effectively attenuated in the output signal relative to the own-voice component contained in the input signal. In some examples, the providing the effective attenuation relative to the input signal comprises activating and/or increasing an active noise cancelling in the output signal. In some examples, the providing the effective attenuation relative to the input signal comprises, e.g., in addition to the active noise cancelling, providing the output signal based on the input signal, e.g., the unprocessed input signal, and/or the noisy signal.

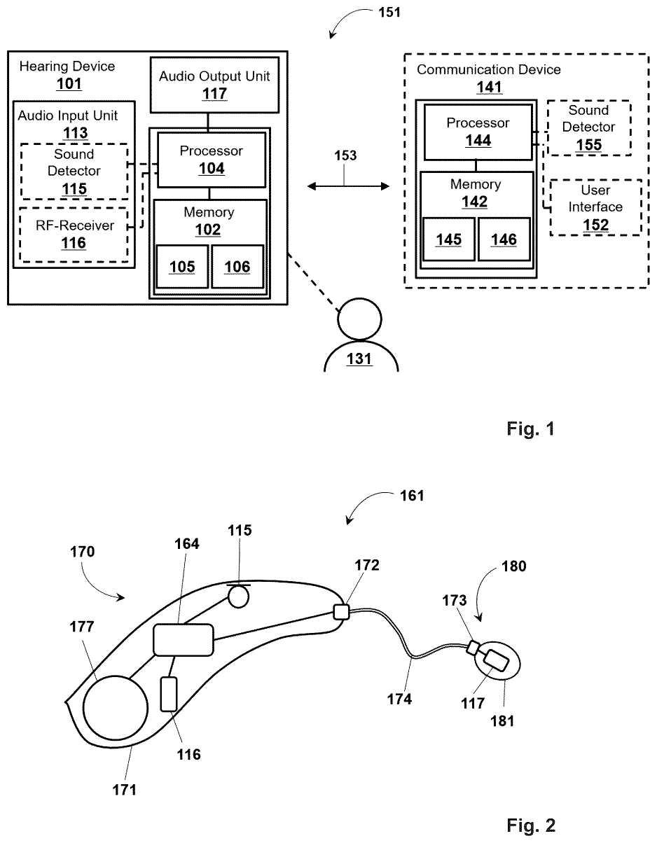

FIG. 1 illustrates an exemplary implementation of a hearing device 101 configured to be worn at an ear of a user 131. Hearing device 101 may be implemented by any type of hearing device configured to enable or enhance hearing or a listening experience of user 131 wearing hearing device 101. For example, hearing device 101 may be implemented by a hearing aid configured to provide an amplified version of audio content to a user, a sound processor included in a cochlear implant system configured to provide electrical stimulation representative of audio content to a user, a sound processor included in a bimodal hearing system configured to provide both amplification and electrical stimulation representative of audio content to a user, an over-the-counter (OTC) hearing device, or any other suitable hearing prosthesis, or an earbud or an earphone or any other hearable.

In certain examples, hearing device 101 may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type. For example, a first hearing device may be a hearing aid and a second hearing device may be a sound processor included in a cochlear implant system.

Different types of hearing device 101 can also be distinguished by the position at which they are worn at the ear. Some hearing devices, such as behind-the-ear (BTE) hearing aids and receiver-in-the-canal (RIC) hearing aids, typically comprise an earpiece configured to be at least partially inserted into an ear canal of the ear, and an additional housing configured to be worn at a wearing position outside the ear canal, in particular behind the ear of the user. Some other hearing devices, as for instance earbuds, earphones, hearables, in-the-ear (ITE) hearing aids, invisible-in-the-canal (IIC) hearing aids, and completely-in-the-canal (CIC) hearing aids, commonly comprise such an earpiece to be worn at least partially inside the ear canal without an additional housing for wearing at the different ear position.

Hearing device 101 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.).

Memory 102 may maintain (e.g., store) executable data used by processor 104 to perform any of the operations associated with hearing device 101. Any suitable data memory can be used for memory 102. Exemplary data memories include, but are not limited to, dynamic random access memories (DRAM), static random access memories (SRAM), random access memories (RAM), solid state drives (SSD), hard drives and/or flash drives. For example, memory 102 may store data representative of a neural network 105 for separating one or more speech signals from an input signal, which may be executed by processor 104. Memory 102 may store further instructions 106 that may be executed by processor 104 to perform any of the operations associated with hearing device 101 described herein. To illustrate, instructions 106 may include instructions for the processing of an input audio signal, e.g., to input the audio signal in neural network 105 and/or to process the one or more of the speech signals separated by neural network 105, e.g., depending on whether the input signal comprises an own-voice component representative of a speech of the user, which may be detected by neural network 105. In some examples, instructions 106 may further include audio signal processing routines, e.g., providing for noise cancelling, active noise cancelling (ANC), feedback cancelling, beamforming, speech enhancement, audio signal classification, audio signal processing programs associated with a current acoustic scene, binaural synchronization, and/or the like. Instructions 106 may be implemented by any suitable application, software, firmware, code, and/or other executable data instance.

Processor 104 may be configured to perform any suitable processing operation associated with hearing device 101. For example, when hearing device 101 is implemented by a hearing instrument, such processing operations may include monitoring ambient sound and/or presenting amplified sound to user 131 via an in-ear receiver. Processor 104 may be implemented by any suitable combination of hardware and software. E.g., processor 104 may be a general purpose processor. Processor 104 may also include special-purpose hardware, such as application specific integrated circuits (ASICs), programmable logic devices (PLDs), field-programmable gate arrays (FPGAs), programmable circuitry (e.g. one or more microprocessor microcontrollers), digital signal processor (DSP), appropriately programmed software and/or computer code, or a combination of special purpose hardware and programmable circuitry. In particular, processor 104 may comprise hardware adapted for processing neural networks, e.g. an AI chip, for example for processing neural network 105.

As shown in FIG. 1, hearing device 101 may further include an audio input unit 113 and an audio output unit 117 communicatively coupled to processor 104. Audio input unit 113 is configured to obtain an input audio signal. Processor 104 is configured to provide for a processing of the input audio signal to obtain an output audio signal. Audio output unit 117 is configured to output sound based on the output audio signal.

In some implementations, as illustrated, audio input unit 113 may comprise a sound detector 115 configured to detect sound in an ambient environment of the user and to provide an ambient audio signal representative of the detected sound. The input audio signal, which is received by processor 104, may then at least partially be based on the ambient audio signal. In some examples, sound detector 115 may be implemented as a microphone and/or a microphone array. In some examples, after detection of the sound in the ambient environment, audio input unit 113 may be configured to prepare the ambient audio signal for an audio signal processing by processor 104. For example, audio input unit 117 may comprise an analog-to-digital converter to convert the ambient audio signal, as detected by sound detector 115, from an analog signal into a digital signal.

In some implementations, as illustrated, audio input unit 113 may comprise a radio receiver 116 configured to receive a radio audio signal from a remote audio source via radio frequency (RF) radiation. The input audio signal, which is received by processor 104, may then at least partially be based on the radio audio signal. Radio receiver 116 may be configured for wireless data reception of the radio audio signal. For instance, the radio audio signal may be received in accordance with a Bluetooth^{TM} protocol and/or by any other type of RF communication. In some examples, the remote audio source may be a remote microphone, e.g., a table microphone or a clip-on microphone, configured to detect sound at a remote location and transmit the radio audio signal indicative of the detected sound to radio receiver 116. In some examples, the remote audio source may be a streaming source configured for streaming the radio audio signal to radio receiver 116. In some examples, the remote audio source may be a communication device, e.g., a portable device such as a smartphone, tablet, smartwatch and/or the like, or a computing device such as a personal computer, configured for data transmission of the radio audio signal to radio receiver 116. In some examples, after reception of the radio audio signal, audio input unit 113 may be configured to prepare the radio audio signal for an audio signal processing by processor 104. For example, when the radio audio signal received from the remote audio source comprises an encoded signal, audio input unit 113 may comprise a decoder to decode the radio audio signal.

Audio output unit 117 may be implemented by any suitable audio output device configured to output sound based on the output audio signal to the user. To this end, audio output unit 117 may include an output transducer. For example, audio output unit 117 may be implemented as a receiver of a hearing aid, a loudspeaker of an earbud, or an output electrode of a cochlear implant.

Hearing device 101 may include further components as may serve a particular implementation. E.g., hearing device 101 may further include a user interface and/or a communication port for data transmission and/or an ear-canal microphone and/or other sensors such as a motion sensor and/or a physiological sensor.

As further illustrated in FIG. 1, a hearing system 151 may include hearing device 101 and may further include a communication device 141 communicatively coupled to hearing device 101. In some examples, communication device 141 is implemented as a portable device, e.g. a smartphone, tablet, smartwatch and/or a wireless microphone. In some examples, communication device 141 provides a user interface 152, e.g. in form of a touch screen, for adjusting hearing device parameters in an intuitive and user-friendly way. For example, a hearing device software, e.g. in form of a mobile app, may be installed on the communication device 141 to allow user interaction with hearing device 101 via user interface 152 of communication device 141.

Hearing device 101 may be communicatively coupled to communication device 141 by a wireless data connection 153. Any suitable protocol may be used for establishing wireless data connection 153. In some examples, wireless data connection 153 may be based on one or more protocols, e.g., Bluetooth, Bluetooth LE audio or similar protocols, such as, for example, Asha Bluetooth, Bluetooth A2DP, Hands-free profile (HFP), Auracast, Unicast and/or a wireless microphone connection. Further exemplary wireless data connections are DM (digital modulation) transmitters, aptX LL and/or induction transmitters (NFMI). Also other wireless data connection technologies, for example, broadband cellular networks, in particular 5G broadband cellular networks, and/or a local network, in particular a wireless local area network (WLAN,) can be used.

Communication device 141 may further include a sound detector 155 configured to detect sound in the ambient environment of the user, e.g., a microphone and/or a microphone array. In some examples, sound detector 155 may be employed to record a speech sample of user 131. The speech sample can be indicative of the user's own-voice and may be employed to customize neural network 105 so that neural network 105 is configured to detect, e.g., separate, the own-voice of user 131 from an input audio signal, as further described below. In some examples, sound detector 115 of hearing device 101 may be employed to record a speech sample of user 131 for this purpose.

Communication device 141 also includes a memory 142 and a processor 144 selectively and communicatively coupled to one another. Memory 142 and processor 144 may each include or be implemented by hardware and/or software components (e.g., processors, memories, communication interfaces, instructions stored in memory for execution by the processors, etc.).

Memory 142 may maintain (e.g., store) executable data used by processor 144 of communication device 141 and/or data for the purpose of being executed by processor 104 of hearing device 101. To illustrate, the data executable by processor 104 of hearing device 101 may be transferred from memory 142 of communication device 141 to memory 102 of hearing device 101 via data connection 153. In some examples, memory 142 may store data representative of one or more neural networks 145 which may be executable by processor 144 of communication device 141 and/or by processor 104 of hearing device 101. E.g., neural network data 145 may be suitable to customize and/or replace neural network data 105 of the neural network for separating one or more speech signals from an input signal. In some examples, memory 142 may store further instructions 146 that may be executed by processor 146 to perform any of the operations described herein.

In some examples, instructions 146 include instructions to customize neural network 105 stored in hearing device 101 and/or neural network 145 stored in communication device 141. E.g., neural network 105, 145 may be customized to the own-voice of user 131 such that neural network 105, 145 can detect the own-voice of user 131 in an input audio signal. In some examples, a speech sample of user 131, which may be recorded by sound detector 115, 155, may be processed so as to provide for an embedding of the user's own-voice in neural network 105, 145 which allows for the detection of the user's own-voice, e.g., by separating the user's own-voice from the input audio signal, as further described below. In some examples, instructions 146 may then include instructions to execute, e.g., by processor 144 of communication device 141 and/or by processor 104 of hearing device 101, an embedding module configured to determine the embedding for the neural network based on the speech sample. In some examples, processor 104 of hearing device 101 may be configured to provide for the embedding in neural network 105. E.g., instructions 106 stored in memory 102 of hearing device 101 may comprise the embedding module which may include instructions to determine the own-voice embedding for neural network 105 based on a speech sample recorded from user 131 via sound detector 115.

FIG. 2 illustrates an exemplary implementation of hearing device 101 as a RIC hearing aid 161. RIC hearing aid 161 comprises a BTE part 170 configured to be worn at an ear at a wearing position behind the ear, and an ITE part 180 configured to be worn at the ear at a wearing position at least partially inside an ear canal of the ear. BTE part 170 comprises a BTE housing 171 configured to be worn behind the ear. BTE housing 171 accommodates a processing unit 164, which may comprise processor 104 and memory 102, communicatively coupled to sound detector 115 and radio receiver 116. BTE part 170 further includes a battery 177 as a power source. ITE part 180 is an earpiece comprising an ITE housing 181 at least partially insertable into the ear canal. ITE housing 181 accommodates audio output unit 117 implemented as a receiver. BTE part 170 and ITE part 180 are interconnected by a cable 174. Processing unit 164 is communicatively coupled to audio output unit 117 of ITE part 180 via cable 174 and cable connectors 172, 173 provided at BTE housing 171 and ITE housing 181.

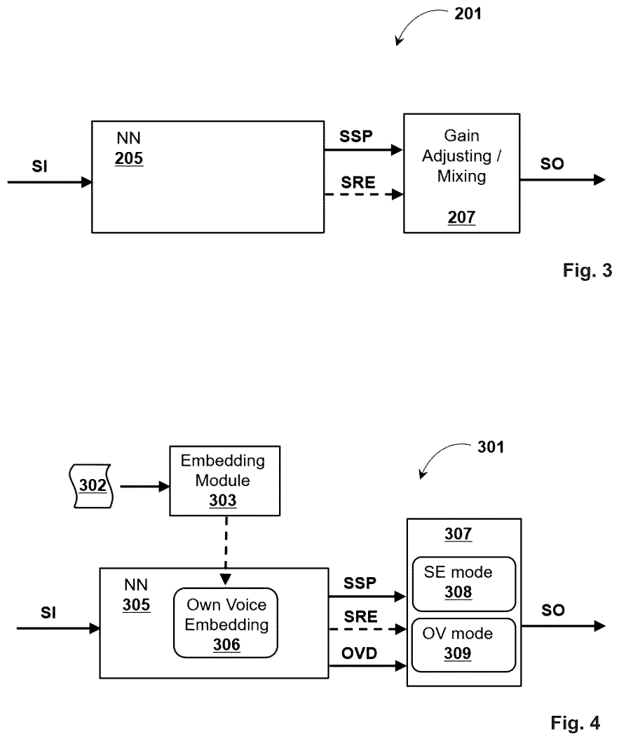

FIG. 3 is a schematic block diagram of a conventional signal processing algorithm 201 for speech enhancement of an input audio signal SI. Algorithm 201 comprises a neural network (NN) 205 for separating one or more speech signals SSP from audio signal SI which is input into neural network 205. In particular, neural network 205 may be implemented as a deep neural network (DNN). Examples of such a neural network are disclosed in US 2022/0093188 A1 and EP 4 440 145 A1.

In some examples, the separated speech signal SSP may be representative of a general speech in the environment of user 131, which may also be referred to as an environmental speech. E.g., separated speech signal SSP may include speech of multiple speakers speaking at the same time, or a single speaker when nobody else is speaking.

In some examples, one or more separated speech signals SSP may each be representative of a speech of a different individual, which may also be referred to as an individual speech. E.g., each separated speech signal SSP may include a speech of another person which may be known to the user such as a significant other, friend, acquaintance or a previous conversation partner. In particular, neural network 205 may be trained to provide for separation of environmental speech and/or individual speech from input signal SI.

In most practically occurring scenarios, input signal SI further contains noise, which superimposes the speech contained in input signal SI, thereby, for example, decreasing its clarity and/or intelligibility. Speech enhancement algorithm 201 has the goal to improve clarity, loudness and/or intelligibility of the speech content of audio signal SI to the user. To this end, an output signal SO presented to user 131 may be based on one or more of the separated speech signals SSP.

In some examples, neural network 205 may be configured to output a residual signal SRE which may be representative of an audio signal based on input signal SI from which the one or more speech signals SSP are separated, e.g., removed, by neural network 205. In particular, residual signal SRE may be representative of input signal SI minus the separated speech signals SSP and/or a sum of all audio signals which have not been separated by neural network 205. In some examples, residual signal SRE may be representative of a noisy signal SN, as further described below.

Residual signal SRE can thus be representative of noise contained in input signal SI, which may also be referred to as a noise component of input signal SI. In some examples, noise may be referred to as any non-speech component contained in audio signal SI. In some examples, residual signal SRE may be representative of a plurality of noise components, e.g., noise stemming from a plurality of different noise sources such as environmental sounds, traffic, music, background voices, etc. In some examples, residual signal SRE may also include speech which has not been separated by neural network 205, e.g., a speech component representative of one or more individuals speaking in the environment. The residual signal SRE may also be referred to as a noisy signal SN.

To provide for the speech enhancement to a desired degree, algorithm 201 may further comprise a gain adjustment and/or mixing module 207. Module 207 can receive one or more of the speech signals SSP separated by neural network 205 as an input. Module 207 may further receive residual signal SRE, when provided by neural network 205, as an input.

Module 207 can be configured to apply a gain on one or more of the separated speech signals SSP and/or to provide for a mixing of one or more separated speech signals SSP with residual signal SRE which may represent a noisy signal. Those operations performed by module 207 may be useful, on the one hand, to provide for an improved enhancement of separated speech signals SSP in output signal SO, and, on the other hand, to reduce processing artefacts in output signal SO which may be caused in the processing of neural network 205.

Moreover, those operations may be useful to provide for a more natural listening experience for user 131, e.g., when decreasing the mixing ratio and/or the applied gain. To illustrate, presenting the speech enhanced output signal SO to user 131 based on one or more separated speech signals SSP may serve the main purpose to improve an intelligibility of the separated speech for the user. This can be beneficial for the user to easier perceive and/or understand the speech during a conversation with a conversation partner, or also when only listening to the speech, e.g., during a presentation. On the downside, a current acoustic scene or environment may be perceived as less realistic when existing background noise is blend out. For example, when background noise is eliminated to a large extent, the user may perceive the acoustic environment as if they were isolated in a bubble, disconnected from their surroundings. This lack of environmental context can lead to unintended consequences, such as the user speaking to softly because they hear others'speech more clearly without the usual ambient noise cues. Such effects may hinder natural communication.

Accordingly, the mixing ratio and/or the gain applied by module 207 may be selected, e.g., by the user via a user input and/or in a self-controlled manner depending on an estimated property of input audio signal SI, so as to provide for a best possible compromise which may balance the user's need of speech enhancement with the benefits of the preservation of relevant background noise. Yet such a trade-off is not always possible. For instance, in rather complex or noisy acoustic environments, or for user's suffering from hearing loss, a desired enhancement of speech intelligibility may be favored at the cost of maintaining a more natural auditory perception based on a reproduction of ambient noise. Yet, also under those circumstances, it would be desirable to provide for a more natural listening experience. Those challenges are addressed by signal processing algorithms 301, 401, 501 for speech enhancement, as described below in conjunction with FIGS. 4, 5, and 8.

FIG. 4 is a schematic block diagram of a signal processing algorithm 301 for speech enhancement. Algorithm 301 comprises a neural network (NN) 305, e.g., a DNN, for providing, in addition to one or more speech signals SSP separated from input audio signal SI, an own-voice detection signal OVD. In some examples, as illustrated, neural network 205 may further be configured to output residual signal SRE.

Own-voice detection signal OVD is indicative of whether input audio signal SI comprises an own-voice component representative of a speech of the user. In some examples, the own-voice component is detected by neural network 305 by separating the own-voice component from audio signal SI. Own-voice detection signal OVD may then be provided as at least one separated speech signal representative of the own-voice component, which may also be denoted as a separated own-voice speech signal SOV. The one or more speech signals separated by neural network (NN) 305 may thus comprise own-voice speech signal SOV. Own-voice speech signal SOV may then also be referred to as a separated speech signal representative of a speech of the user. The one or more separated speech signals SSP may then also be referred to as separated speech signals representative of a speech in the environment of the user and/or representative of a speech of one or more speakers different from the user.

To illustrate, neural network 305 may comprise an own-voice detection output designated for outputting the separated own-voice speech signal SOV. When the own-voice detection output of neural network 305 then provides a blank signal or a signal of a rather low signal level, the own-voice component may be regarded as being undetected in input audio signal SI. When the own-voice detection output, however, outputs a separated own-voice speech signal SOV, e.g., an audio signal exceeding a minimum signal level, the own-voice component may be regarded as being detected in input audio signal SI.

In some examples, the own-voice component is detected by neural network 305 by classifying one or more of the separated speech signals SSP with regard to a likelihood that the own-voice component is contained, or not contained, in the separated speech signal. In this regard, neural network 305 may be configured to perform, after separating speech signal SSP from audio signal SI the classification of the separated speech signal SSP in at least two classes representative of whether the user's own-voice is contained in the separated speech signal SSP, or not.

To illustrate, when the separated speech signal SSP is representative of general speech in the environment of user 131, the classification may indicate whether at least one of multiple speech components from various speakers in the environment, which may all be represented in the separated speech signal SSP, can be attributed to the speech of the user as the own-voice component.

For the purpose of detecting whether the input signal SI comprises an own-voice component of the user, neural network 305 may be conditioned to the user's own-voice. To this end, neural network 305 may be provided with an embedding 306 representative of the user's own-voice, e.g., representative of unique vocal characteristics of the own-voice such as pitch, timbre, and speaking style. Own-voice specific embedding 306 may thus represent a numerical representation, e.g., in a latent space, characterizing the user's own-voice. Embedding 306 can then allow neural network 305 to distinguish the own-voice from competing speech signals and/or to extract the own-voice from a mixture of multiple voices and/or background noise. E.g., neural network 305 may be based on neural network 205 with included embedding 303. In some cases, embedding 306 may be implemented in the neural network such that embedding 306 is concatenated with acoustic features of audio signal SI extracted from audio signal SI by the neural network. In some cases, neural network 305 may be fine-tuned using a dataset where own-voice specific embedding 306 is used as a conditioning signal.

The embedding may be derived by an embedding module 303. To this end, a speech sample 302 of the user representative of the user's own-voice may be input, e.g., enrolled, in embedding module 303. The speech sample 302 may be processed by embedding module 303, e.g., as an enrollment audio, to create the own-voice specific embedding 306. The processing may include extraction of acoustic features from speech sample 302, for example Mel-frequency cepstral coefficients (MFCCs) and/or the like. Embedding module 303 may further include an embedding encoder, e.g., a pretrained DNN, generating embedding 306, e.g., as a fixed-dimensional vector, from the extracted features. Embedding module 303 may further include an embedding integrator for integrating embedding 306 into an existing neural network. The integration may be performed by various techniques which may include concatenation, e.g., by adding embedding 306 as an extra input at one or more different layers of neural network 305; and/or Adaptive Layer Normalization (AdaLN), e.g., by using embedding 306 to modulate layer statistics; and/or attention mechanisms, where embedding 306 may act as a query to focus on relevant speech components; and/or gating mechanisms, which may emphasize the own-voice specific features while suppressing others.

Embedding module 303 may be implemented in communication device 141, e.g. in the form of instructions 146, and/or in hearing device 101, e.g. in the form of instructions 116. Speech sample 302 of user 131 may be recorded by sound detector 155 of communication device 141 and/or sound detector 115 of hearing device 101. Embedding 306 generated by module 303 may be stored in memory 102 of hearing device 102 and/or in memory 142 of communication device 141 such that it can be transmitted dynamically to hearing device 102 via data connection 153.

As illustrated, algorithm 301 further comprises a gain adjustment and/or mixing module 307. Module 307 can receive one or more of the speech signals SSP separated by neural network 205 as an input. Module 307 can further receive own-voice detection signal OVD as an input. Module 307 may further receive residual signal SRE, when provided by neural network 305, as an input.

Module 307 is configured to operate in different operational modes, which may be activated depending on own-voice detection signal OVD. The operational modes comprise a first operational mode 308 and a second operational mode 308. When own-voice detection signal OVD is indicative of an own-voice component being undetected in audio signal SI, first operational mode 308 may be activated. When own-voice detection signal OVD is indicative of an own-voice component being detected in audio signal SI, second operational mode 308 may be activated.

First operational mode 308 is a speech-enhancement mode (SE mode) for enhancing one or more of the separated speech signals SSP. In some examples, first operational mode 308 may operate in accordance with gain adjustment and/or mixing module 207 described above in conjunction with FIG. 3.

Second operational mode 309 is an own-voice attenuation mode (OV mode) for processing input signal SI so as to provide for an effective attenuation of the own-voice component in the output signal SO relative to one or more of the separated speech signals included in the output signal SO in first operational mode 308. The effective attenuation may provide for a reduced intelligibility and/or perceptibility of the own-voice component in the output signal SO for user 131 as compared to one or more of the separated speech signals in the output signal SO when the own-voice component is undetected.

In some examples, the effective attenuation may be provided by reducing, when the own-voice component is detected, an amplification of the own-voice component OVD in output signal SO and/or increasing, when own-voice component OVD is detected, noise in output signal SO. This may be achieved, for instance, by lowering a signal level and/or lowering a signal to noise ratio of the own-voice component in output signal SO when the own-voice component is detected as compared to the signal level and/or signal to noise ratio applied in the processing of one or more of the separated speech signals when the own-voice component is undetected. In some examples, the effective attenuation may be provided by excluding the one or more separated speech signals SSP from output signal SO, in particular by excluding the own-voice component OVD which may be separated by DNN 305 as own-voice speech signal SOV, from output signal SO. In place of the one or more separated speech signals SSP, a noisy signal SN may be included in output signal SO. E.g., the noisy signal SN may be based on residual signal SRE and/or the unprocessed input audio signal SI and/or any other signal in which noise contained in input audio signal SI is preserved to a larger extent than in the one or more separated speech signals SSP.

Operating speech-enhancement algorithm 301 in second operational mode 309, as described above, can offer the advantage to restore a naturalness of the acoustic environment perceived by user 131, at least at a time when user 131 is speaking. In this context, the circumstance may be exploited that during the times in which user 131 speaks, an improvement of the intelligibility of the user's own voice (as carried out in first operational mode 308 for the one or more separated speech signals SSP) can be reduced or eliminated for the reason that user 131 is already conscious about the content of their own speech without the need to listen to the own speech. The restoring of the naturalness of the acoustic surrounding, at least to a certain extent, can increase the user's comfort in that they feel less detached from their surroundings.

In this regard it may be noteworthy that an increasing of noise in output signal SO when the own-voice component OVD is detected can be more appropriate or more effectful for restoring the naturalness of the acoustic environment as compared to reducing the amplification of the own-voice component. To illustrate, the natural sound occurring in the environment may be most prominently different and/or most recognizably distinguished from the one or more separated speech signals SSP by the noise which is additionally present in the environmental sound so that the speech is harder to perceive or comprehend. Accordingly, adding the noise rather than decreasing the own-voice amplification can make output signal SO more similar to the environmental sound when presented to the user. In particular, decreasing a mixing ratio defining a ratio of the denoised signal SD relative to the noisy signal SN in output signal SO and/or applying an increased gain on the noisy signal SN when the own-voice component is undetected may be applied to restore the environmental naturalness.

As a further advantage, when operating in second operational mode 309, a natural speech behavior of user 131 may be restored by preserving noise and/or other auditory distractions in the output signal SO. To illustrate, in typical environments, humans unconsciously adjust the intensity and pitch of their voice based on the surrounding noise level, a phenomenon known as the Lombard effect. When ambient noise increases, speakers naturally raise their voices to maintain intelligibility. Conversely, when the environment is quieter, speakers reduce their vocal effort. Since speech-enhancement algorithm 301, at least when operating in first operational mode 308, may artificially suppress background noise for the user, the expected auditory cues that would normally trigger this compensatory behavior are diminished or entirely absent. In other words, the Lombard effect would be missing. To compensate for the missing Lombard effect, second operational mode 309 may be activated during the user's speech. In this way, communication difficulties arising during the speech enhancement performed by algorithm 301 can be mitigated or avoided.

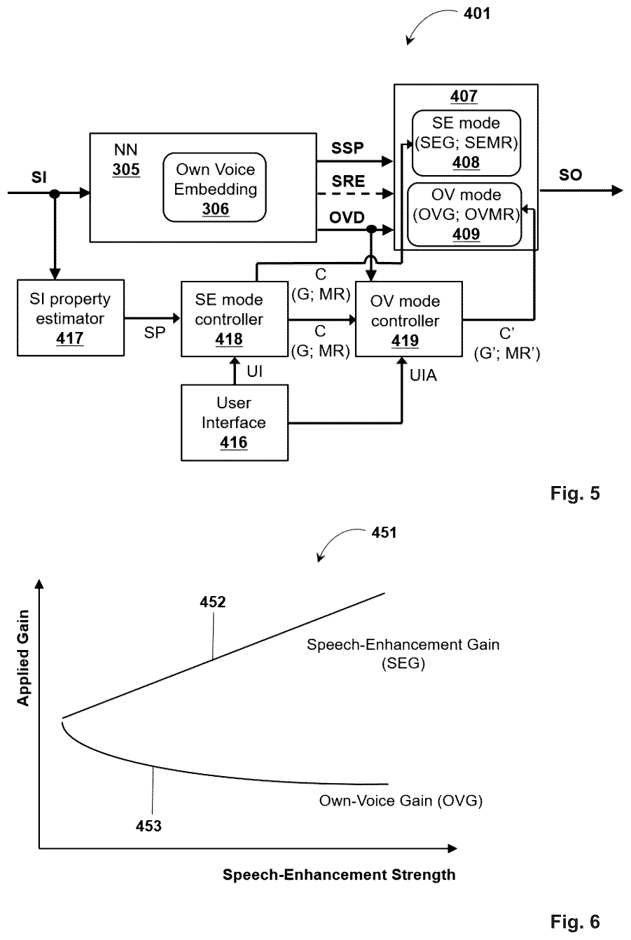

FIG. 5 is a schematic block diagram of another signal processing algorithm 401 for speech enhancement. Algorithm 401 comprises a gain adjustment and/or mixing module 407 providing the functionality of module 307 described above. In particular, module 407 provides for a first operational mode 408, which may be referred to as speech-enhancement mode (SE mode), and a second operational mode 409, which may be referred to as own-voice attenuation mode (OV mode). Algorithm 401 further comprises a first controller 418 for controlling SE mode 408 of module 407. Algorithm 401 further comprises a second controller 419 for controlling OV mode 409 of module 407.

Speech-enhancement mode controller 418 can be configured to control the enhancing of one or more of the separated speech signals SSP, which may be performed by module 407 in speech-enhancement mode 408 when the own-voice component is undetected in input signal SI. To this end, controller 418 may provide control parameters C to module 407, which can be applied by module 407 to one or more of the separated speech signals SSP during operating in SE mode 408. Control parameters C may also be referred to as speech-enhancement control parameters. In some examples, control parameters C comprise a gain parameter G, which may also be referred to as a speech-enhancement gain parameter. In some examples, control parameters C comprise a mixing ratio parameter MR, which may also be referred to as speech-enhancement mixing ratio parameter.

When receiving gain parameter G from controller 418, module 407 may apply a gain to one or more of the separated speech signals SSP depending on gain parameter G. The applied gain may provide for an improved enhancement of one or more separated speech signals SSP in output signal SO, and may also be referred to as a speech-enhancement gain SEG. The speech-enhancement gain SEG may be frequency-dependent.

In some examples, the applied gain SEG may be employed to compensate for a loss on one or more of speech signals SSP which may occur during the separation by neural network 205. Such a loss may depend on different signal properties SP of input audio signal SI. The properties may comprise, e.g., one or more of a signal-to-noise ratio (SNR), a sound pressure level (SPL), an estimate of a noise floor (NFE), and/or a low frequency level (LFL) of audio signal SI. One or more of the properties, e.g., the NFE, may be frequency-dependent. For example, a loss affecting one or more separated speech signals SSP may increase with increasing SNR of input signal SI. Accordingly, the speech-enhancement gain applied on separated speech signal SSP may be selected to compensate for the loss on signal SSP depending on the signal property, e.g., the SNR, of input signal SI. The signal property of input signal SI may vary over time, and, correspondingly, the speech-enhancement gain may be provided so as to adapt to the temporal variation of the speech-enhancement gain. Further, the applied gain may be frequency dependent so as to compensate for a frequency dependency of the loss on separated speech signal SSP.

In some examples, the applied gain SEG may also be employed to account for processing parameters different from the loss compensation on separated speech signal SSP. In some instances, the SEG may be provided so as to compensate for an individual hearing loss of user 131. E.g., the processing parameters may define a gain which is fitted, e.g., by a health care professional (HCP) to an auditory threshold of user 131. In some instances, the SEG may also be selectable by a user input. E.g., user 131 may indicate preferred settings or values of the applied gain SEG via a user interface 416 on hearing device 101 and/or communication device 141.

When receiving the mixing ratio parameter MR from controller 418, module 407 can be configured to provide for a mixing of one or more separated speech signals SSP, which may represent a denoised signal SD, with a noisy signal SN. The mixing can be performed at a mixing ratio which may define a proportion of one or more separated speech signals SSP relative to a proportion of noisy signal SN in output signal SO. The mixing ratio may depend on the mixing ratio parameter MR and may also be referred to as a speech-enhancement mixing ratio (SEMR). E.g., the mixing ratio SEMR may be representative of strength of the speech enhancement provided by algorithm 401.

The noisy signal SN may be representative of a signal in which noise contained in input audio signal SI is preserved to a larger extent than in the one or more separated speech signals SSP. In some instances, the noisy signal SN may be provided as input audio signal SI in an unprocessed form, or as input audio signal SI which has been processed but still contains a larger noise component as compared to denoised signal SD. In some instances, the noisy signal SN may be output by neural network 305, e.g. as residual signal SRE. In some examples, separated speech signals SSP are mixed with the noisy signal SN in an unmodified form. In some examples, one or more of the separated speech signals SSP are mixed with the noisy signal SN after the gain SEG has been applied on one or more of the separated speech signals SSP, as described above.

The mixing of one or more separated speech signals SSP with noisy signal SN can be useful to reduce processing artefacts in speech signal SSP which may be produced by neural network 305 in the separation process. In this regard, a larger proportion of noisy signal SN in output signal SO may contribute to an improved masking of the artefacts when output to user 131.

The mixing may also be useful to provide for a more natural listening experience for user 131. E.g., when decreasing mixing ratio SEMR at the cost of a reduced intelligibility of the separated speech SSP in output audio signal SO, a perceived naturalness of the acoustic environment by the user, e.g., in terms of an increased awareness of background noise, can be achieved.

In some examples, the mixing ratio SEMR may be determined based on a user input UI. E.g., user 131 may indicate a preferred ratio of the mixing via a user interface 416 on hearing device 101 and/or communication device 141.

In some examples, the mixing ratio SEMR may be determined based on one or more signal properties SP of input audio signal SI, e.g., an SNR, SPL, NFE, and/or a LFL of audio signal SI. In some examples, the mixing ratio may be determined based on a current acoustic scene. E.g., the acoustic scene may be determined by an acoustic scene classifier, which may be implemented in hearing device 101 in the form of instructions 106. To illustrate, when the acoustic scene classification indicates a rather noisy environment, the proportion of noisy signal SN in output signal SO may be kept lower as compared to in a less noisy environment.

In some examples, the mixing ratio SEMR may also be determined depending on a hearing loss of the user. E.g., when user 131 is suffering from a moderate or severe hearing loss, the mixing ratio SEMR may be determined to be larger as compared to when the user has normal hearing or a mild hearing loss. In particular, such a dependency of the mixing ratio SEMR on a hearing loss may be accounted for in a fitting of hearing device 101 to an individual hearing loss of user 131.

Accordingly, the gain SEG and/or the mixing ratio SEMR applied by module 407 in SE mode 408 can be controlled by gain parameter G and/or mixing ratio parameter MR received from controller 418. To provide for a dependency of the applied gain SEG and/or mixing ratio SEMR on the user's preferences, controller 418 may receive user input UI from user interface 416. To provide for a dependency of the applied gain SEG and/or mixing ratio SEMR on one or more signal properties SP of audio signal SI, controller 418 may receive information about the one or more signal properties SP from a signal property estimator (SI property estimator) 417. In some examples, signal property estimator 417 may be configured to determine, upon receiving input signal SI, one or more signal properties SP, which may include one or more of an SNR, SPL, NFE, and/or a LFL of audio signal SI. In some examples, signal property estimator 417 may include an acoustic scene classifier which may provide the signal property SP indicative of a current acoustic scene, e.g., speech, non-speech, speech-in-noise, silent, noise, music, etc. User input UI and/or signal properties SP may thus be taken into account by module 407 when determining gain parameter G and/or mixing ratio parameter MR for controlling the gain SEG and/or mixing ratio SEMR to be applied by module 407.

Own-voice attenuation mode (OV mode) controller 419 can be configured to control module 407 for the processing of input signal SI so as to provide for an effective attenuation of the own-voice component in the output signal SO in own-voice attenuation mode 409. To this end, controller 419 may provide control parameters C′ to module 407, which can be applied by module 407 to the own-voice component contained in input signal SI during operating in OV mode 409. Control parameters C′ may also be referred to as own-voice control parameters. In some examples, control parameters C′ comprise a gain parameter G′, which may also referred to as an own-voice gain parameter. In some examples, control parameters C′ comprise a mixing ratio parameter MR′, which may also referred to as an own-voice mixing ratio parameter.

OV mode controller 419 may receive speech-enhancement control parameters C from SE mode controller 418, in particular speech-enhancement gain parameter G and/or speech-enhancement mixing ratio parameter MR, which are employed for applying the gain SEG and/or mixing ratio SEMR in speech-enhancement mode 408. Based on speech-enhancement control parameters C, OV mode controller 419 can determine own-voice control parameters C′, in particular own-voice gain parameter G′ and/or own-voice mixing ratio parameter MR, which are then employed for applying an own-voice gain OVG and/or an own-voice mixing ratio OVMR by module 407 in own-voice attenuation mode 409. The own-voice gain OVG may be frequency-dependent.

In some examples, own-voice control parameters C′ can be determined such that an increased, e.g., more aggressive, speech enhancement caused by speech-enhancement control parameters C in speech-enhancement mode 408 will lead to an increased (or more aggressive) effective attenuation of the own-voice component caused by own-voice control parameters C′ in OV mode 409. Conversely, own-voice control parameters C′ may be determined such that a reduced speech enhancement caused by speech-enhancement control parameters C in speech-enhancement mode 408 will also lead to a reduced effective attenuation of the own-voice component caused by own-voice control parameters C′ in OV mode 409. In some examples, the own-voice component included in output signal SO may be effectively attenuated by a similar or proportional level in OV mode 409 as noise in output signal SO in SE mode 408.

This way of determining own-voice control parameters C′ may be based on the rationale that a degree of speech enhancement effectuated by speech-enhancement control parameters C, which may also be referred to as a speech-enhancement strength, can be directly related to the amount of background noise present in the acoustic surroundings. Accordingly, the larger the speech-enhancement strength the more effective attenuation of the own-voice component would be required so as to restore a naturalness of the acoustic surroundings. In particular, the more background noise present in the acoustic surroundings, the louder the user must speak so as to be comprehensible by a conversation partner. Accordingly, the larger the speech-enhancement strength, the more effective attenuation of the own-voice component would be required so as to compensate for the missing Lombard effect and to provoke the user to raise his own-voice to a volume required for speaking with the conversation partner.

In some examples, when the speech-enhancement gain SEG is determined to be increased by speech-enhancement gain parameter G′, the own-voice gain OVG is determined to be decreased by own-voice gain control parameter G′. An illustrative example is depicted in FIG. 6.

FIG. 6 illustrates a graph 451 of functional curves 452, 453 of the speech-enhancement gain SEG and the own-voice gain OVG as they can be correspondingly applied in SE mode 408 and in OV mode 409 in a given acoustic environment. The speech-enhancement strength is displayed on an axis of abscissas. The applied gain is displayed on an axis of ordinates. In the illustrated example, the speech-enhancement gain 452 increases linearly with the speech-enhancement strength. Conversely, the own-voice gain 453 decreases with the speech-enhancement strength to provide for the effective attenuation of the own voice component in output signal SO. In the illustrated example, the own-voice gain 453 decreases super-linearly at lower values of the speech-enhancement strength with a decreasing slope such that the decrease saturates at higher values of the speech-enhancement strength.

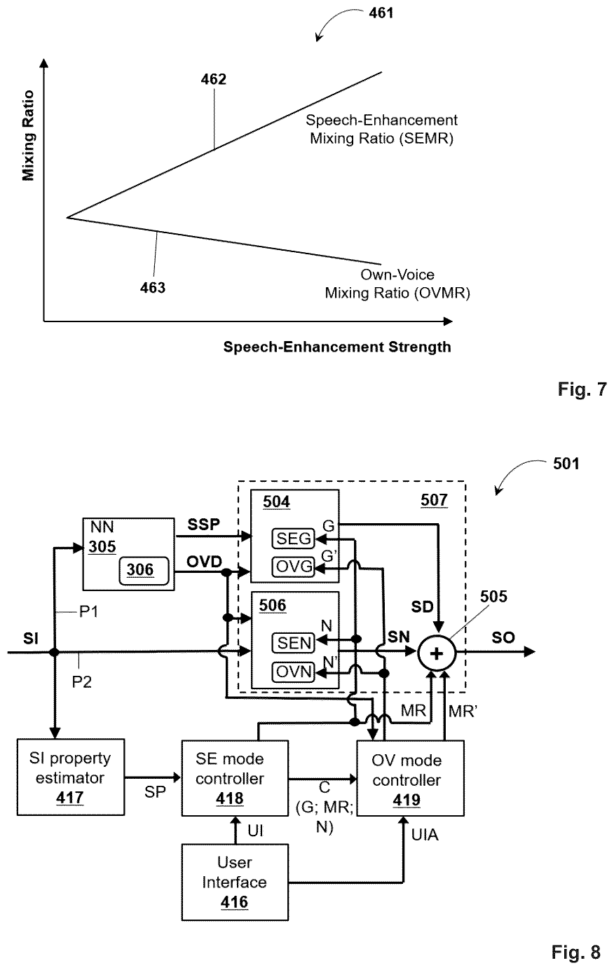

In some examples, when the speech-enhancement mixing ratio SEMR is determined to be increased by speech-enhancement mixing-ratio parameter MR, the own-voice gain OVG is determined to be decreased by own-voice mixing-ratio control parameter MR′. An illustrative example is depicted in FIG. 7.

FIG. 7 illustrates a graph 461 of functional curves 462, 463 of the speech-enhancement mixing ratio SEMR and the own-voice mixing ratio OVMR to be applied in SE mode 408 and in OV mode 409 in a momentary acoustic surrounding. The speech-enhancement strength is displayed on an axis of abscissas. The mixing ratio is displayed on an axis of ordinates. In the illustrated example, the speech-enhancement mixing ratio 462 increases linearly with the speech-enhancement strength. Conversely, the own-voice mixing ratio 463 decreases with the speech-enhancement strength to provide for the effective attenuation of the own voice component in output signal SO. In the illustrated example, the own-voice gain 463 decreases linearly at a smaller slope than the speech-enhancement mixing ratio 462 increases.

OV mode controller 419 may also receive own-voice detection signal OVD from neural network 305. Own-voice control parameters C′, in particular own-voice gain control parameter G′ and/or own-voice mixing-ratio control parameter MR′ may then also be determined based on one or more properties of own-voice detection signal OVD. In this way, the own-voice gain OVG and/or the own-voice mixing ratio OVMR applied in OV mode 409 can also depend on own-voice detection signal OVD. To this end, OV mode controller 419 can be configured to estimate the one or more properties of own-voice detection signal OVD.

In some examples, the one or more properties of own-voice detection signal OVD for controlling the own-voice gain OVG and/or the own-voice mixing ratio OVMR comprise a signal level of own-voice detection signal OVD, in particular own-voice speech signal SOV. To illustrate, the signal level may be representative of a volume of the user's speech. The signal level can thus indicate whether the user's speech is loud enough with regard to the current acoustic environment, in particular the amount of background noise in the environment. To this end, OV mode controller 419 may receive further input from signal property estimator 417 in the form of one or more signal properties SP of audio signal SI, and/or from neural network NN 305 in the form of residual signal SRE, which may also be representative of the background noise prevailing in the environment. In some examples, the signal level of own-voice detection signal OVD may be compared to a predefined value of the signal level, e.g., a baseline value, representative of a volume of the user's speech which would be appropriate for the current acoustic environment, e.g., the amount of current background noise. When the user's speech is loud enough, own-voice control parameters C′ may be determined such that own-voice gain OVG and/or the own-voice mixing ratio OVMR is kept equal. When the user's speech is not loud enough, own-voice control parameters C′ may be determined such that own-voice gain OVG and/or the own-voice mixing ratio OVMR is decreased so as to motivate the user to raise the volume of his speech to the appropriate level.

In some examples, OV mode controller 419 may receive input from user 131 via user interface 416. The user input may be provided in the form of user input signal UI, which is also provided to SE mode controller 418, or as a separate user input in the form an auxiliary user input signal UIA. User input UI, UIA may thus also be taken into account by module 407 when determining gain parameter G′ and/or mixing ratio parameter MR′ for controlling the own-voice gain SEG and/or own-voice mixing ratio SEMR to be applied by module 407 in OV mode 409.

In some examples, OV mode controller 419 can be configured to determine own-voice control parameters C′, in particular own-voice gain control parameter G′ and/or own-voice mixing-ratio control parameter MR′, based on one or more signal properties SP of input audio signal SI, e.g., an SNR, SPL, NFE, and/or a LFL of audio signal SI. E.g., OV mode controller 419 may receive one or more signal properties SP from a signal property estimator 417. The own-voice gain OVG and/or own-voice mixing ratio OVMR applied by module 407 in OV mode 409 may thus depend on one or more of signal properties SP. To illustrate, when signal properties SP are indicative of a smaller SNR of input audio signal SI, the own-voice gain OVG and/or own-voice mixing ratio OVMR applied by module 407 in OV mode 409 may be controlled to be reduced as compared to when signal properties SP are indicative of a larger SNR of input audio signal SI. In this way, an increased amount noise in input audio signal SI can be accounted for in output signal SO in OV mode 409 so as to restore a naturalness of output signal SO presented to the user during his speech and/or to compensate for the missing Lombard effect.

In some examples, OV mode controller 419 can be implemented as a model configured to determine own-voice control parameters C′ based on one or more of speech-enhancement control parameters C; and/or one or more of signal properties SP of input signal SI; and/or one or more properties of the own-voice component OVD; and/or user input signal UIA. In some examples one or more of speech-enhancement control parameters C; one or more of signal properties SP of input signal SI; one or more properties of the own-voice component OVD; or user input signal UIA are input into the model which then determines and outputs the own-voice control parameters C′. In some examples, the model is implemented as a machine learning (ML) algorithm. The ML algorithm may be trained based on data collected in a database. The training data may comprise data representative of one or more of the inputs (e.g., speech-enhancement control parameters C; and/or one or more of signal properties SP of input signal SI; and/or one or more properties of the own-voice component OVD; and/or user input signal UIA) which may be labelled with corresponding, e.g., desired, values of the own-voice control parameters C′.

FIG. 8 is a schematic block diagram of another signal processing algorithm 501 for speech enhancement. Algorithm 501 comprises two signal paths P1, P2 in which audio signal SI is input. At the end of first path P1, a denoised signal SD is obtained. Denoised signal SD can be based on one or more speech signals SSP separated by neural network 305. At the end of second path P2 a noisy signal SN is obtained. Denoised signal SD and noisy signal SN are then mixed by a mixing module 505 so as to obtain a mixed signal on which output signal SO can be based.

Neural network 305 is provided at first path P1. Second path P2 bypasses first path P1. Speech enhancement algorithm 501 further comprises a gain adjustment and mixing module 507 providing for a functionality corresponding to module 307, 407 described above. Module 507 comprises a gain application module 504, a noise adjustment module 506, and mixing module 505.

Gain application module 504 is provided at first path P1 subsequent to neural network 305. Module 504 can receive one or more separated speech signals SSP and own-voice detection signal OVD. Depending on whether the own-voice component is detected by neural network 305 or not, module 504 can operate in SE mode 308, 408 or in OV mode 309, 409. In the SE mode, module 504 can apply speech-enhancement gain SEG on the one or more separated speech signals SSP, as controlled by SE mode controller via SE gain parameter G. In the OV mode, module 504 can apply own-voice gain OVG on the own voice component, as controlled by OV mode controller via OV gain parameter G′. In some examples, the own-voice gain OVG may be set to zero so that the own-voice detection signal OVD, in particular own-voice speech signal SOV, is excluded in output signal SO. After the gain application in the SE mode or in the OV mode, module 504 may output the gain adjusted denoised signal SD to mixing module 505.

Input signal SI may generally contain multiple components superimposing each other. The component may include, e.g., background noise and/or one or more speech components, some of which may correspond to one or more of the speech signals SSP separated by neural network 305 at first path P1, and/or the own-voice component, which may correspond to own-voice speech signal SOV when separated by neural network 305 at first path P1. Noisy signal SN obtained at second path P2 based on input signal SI may thus be representative of a signal in which noise contained in input audio signal SI is preserved to a larger extent than in the one or more separated speech signals SSP.

In some examples, noisy signal SN obtained at the end of second path P2, corresponds to the unprocessed input signal SI. This implies that no signal processing occurs at second path P2. Noisy signal SN may thus be representative of input signal SI.

In some examples, as illustrated, noise adjustment module 506 may be provided at second path P2. Noise adjustment module 506 can thus receive input signal SI. Module 506 may further receive own-voice detection signal OVD. Module 506 may thus also operate in SE mode 308, 408 or in OV mode 309, 409 depending on whether the own-voice component is detected by neural network 305 or not. When operating in the SE mode, module 506 may apply a gain on input signal SI. The applied gain is thus in particular applied on the background noise component contained in input signal SI, in addition to the other components, e.g., the own-voice component and/or other speeches. The applied gain may thus also be referred to as speech-enhancement noise gain (SEN). The speech-enhancement noise gain SEN may be frequency-dependent. The application of the SEN gain may be controlled by SE mode controller 418 via a SEN gain parameter N.

When operating in the OV mode, module 506 may also apply a gain on input signal SI, which may be referred to as own-voice noise gain (OVN). The own-voice noise gain OVN may be frequency-dependent. The application of the OVN gain may be controlled by OV mode controller 419 via a OVN gain parameter N′.

In some examples, the own-voice noise gain may be provided to be larger than the speech-enhancement noise gain. In this way, noisy signal SN can be more amplified in OV mode 309, 409 than in SE mode 308, 408. As a result, output signal OS can be provided with a larger contribution of the background noise in the OV mode than in the SE mode. This can contribute to the effective attenuation of the own-voice component in output signal SO when the own-voice component is detected in input signal SI.

Mixing module 505 may also be configured to operate in SE mode 308, 408 or in OV mode 309, 409 depending on whether the own-voice component is detected by neural network 305 or not. To this end, mixing module 505 may receive own-voice detection signal OVD. In the SE mode, mixing module 505 may apply mixing ratio SEMR on denoised signal SD relative to noisy signal SN, as controlled by the mixing ratio parameter MR received from SE mode controller 418. In the OV mode, mixing module 505 may apply mixing ratio OVMR on denoised signal SD relative to noisy signal SN, as controlled by the mixing ratio parameter MR′ received from OV mode controller 419.

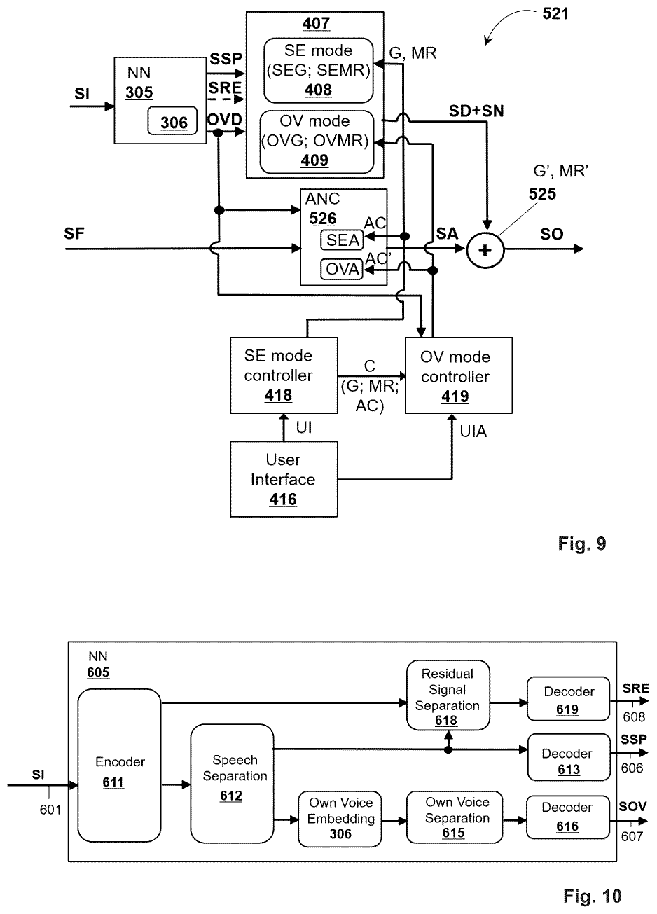

FIG. 9 is a schematic block diagram of another signal processing algorithm 521 for speech enhancement. Algorithm 521 comprises an active noise cancelling (ANC) module 526. ANC module 526 is configured to provide for ANC in output signal SO. To this end, ANC module 526 can receive a feeding audio signal SF. ANC module 526 can be employed to attenuate direct sound entering the ear-canal of user 131, e.g., below a transparency of the direct sound. Direct sound may be representative of sound entering the ear-canal of user 131 from an ambient environment of user 131. The direct sound may thus be presented to user 131 in addition or in place of sound outputted by hearing device 101, for example sound based on output signal SO outputted by audio output unit 117. E.g., hearing device 101 may include a vent through which direct sound may enter the ear-canal.

Feeding audio signal SF may comprise a feedforward audio signal, which may be provided by a feedforward microphone, and/or a feedback audio signal, which may be provided by a feedback microphone. Hearing device 101 may include the feedforward microphone and/or the feedback microphone. The feedforward microphone may be configured to provide the feedforward signal representative of the acoustic environment of user 131. E.g., the feedforward microphone may be implemented as sound detector 115. The feedforward signal may then correspond to input signal SI. The feedback microphone may be configured to provide the feedback signal representative of sound detected in an ear-canal of user 131. E.g., the feedback microphone may be implemented as an ear-canal microphone.

In some examples, as illustrated, ANC module 526 is provided at a separate signal path which may bypass the signal path at which neural network 305 and gain adjustment and/or mixing module 407 are provided. In some examples, ANC module 526 may be provided at the same signal path as neural network 305, e.g., after module 407. ANC module 526 may output an ANC signal SA suitable to provide for the ANC in output signal SO for attenuating the direct sound. ANC signal SA may be combined, e.g., by a signal combiner 525, with denoised signal SD, which may be mixed with a noisy signal SN as described above. Denoised signal SD may be based on one or more speech signals SSP separated by neural network 305. Noisy Signal SN may be based on residual signal SRE and/or input signal SI, e.g., the unprocessed input signal, provided at second path P2.

ANC module 526 may be configured to operate in SE mode 408 or in OV mode 409 depending on whether the own-voice component is detected by neural network 305 or not. To this end, ANC module 526 may receive own-voice detection signal OVD. In SE mode 408, ANC module 526 may deactivate ANC or provide for ANC at a predefined strength of the ANC. A speech-enhancement ANC strength SEA may be representative of the strength of the ANC to be applied when the own-voice component is undetected. In some examples, the ANC strength may be controlled by SE controller 418 based on a user input UI via user interface 416. To this end, SE mode controller 418 may provide an ANC strength parameter AC based on which speech enhancement ANC strength SEA is controlled. In some examples, the ANC strength may be controlled by SE controller 418 based on one or more signal properties SP of input signal SI, e.g., an SNR, SPL, NFE, and/or a LFL of audio signal SI, which may be provided by signal property estimator 417.

In OV mode 409, ANC module 526 may activate ANC or provide for ANC at an increased strength of the ANC as compared to speech-enhancement ANC strength SEA in SE mode 408. An own-voice ANC strength OVA may be representative of the strength of the ANC to be applied when the own-voice component is detected. OV mode controller 419 may provide an ANC strength parameter AC′ based on which speech enhancement ANC strength SEA is controlled. In this regard, it may be noteworthy that ANC can be particularly effective at low to mid frequencies (e.g., between 50 Hz to 500 Hz) allowing to effectively attenuate the own-voice component (and/or other speech components) in the direct sound, e.g., when detected in input signal SI, by including ANC signal SA in output signal SO.

In some examples, the own-voice ANC strength OVA may be set to a predefined value, e.g., a constant value, which may not depend on further input. In some examples, the own-voice ANC strength OVA may be determined based on one or more signal properties SP of input signal SI, which may be provided by signal property estimator 417. E.g., own-voice ANC strength OVA may be increased with a decreasing signal-to-noise ratio of input signal SI so as to account for an increased amount of noise in input signal SI. In some examples, the own-voice ANC strength OVA may be determined based on one or more signal properties SP of input signal SI. In some examples, the own-voice ANC strength OVA may be determined based on speech-enhancement ANC strength SEA in the SE mode and/or based on speech enhancement gain SEG in the SE mode and/or based on the speech enhancement mixing ratio SEMR in the SE mode. To this end, OV mode controller 419 may receive ANC strength parameter AC and/or gain parameter G and/or mixing ratio parameter MG from SE mode controller 418. E.g., the own-voice ANC strength OVA may be determined to be increased relative to the speech-enhancement ANC strength SEA by a predetermined offset. E.g., the own-voice ANC strength OVA may be determined to be increased with increasing values of the enhancement gain SEG in the SE mode and/or with increasing values of the mixing ratio SEMR in the SE mode.

To illustrate, activating ANC or providing for an increased ANC strength in OV mode 409 can be employed to provide for an effective attenuation of the own-voice component contained in direct sound when the own-voice component is detected relative to output signal SO in SE mode 408 when the own-voice component is undetected and in which ANC is deactivated or not provided at the increased strength. Thus, activating ANC or providing for the increased ANC strength may also be employed to restore a perceived naturalness of the acoustic environment and/or to compensate for the missing Lombard effect.

In some examples, activating ANC or providing for an increased ANC strength can be employed to provide for an effective attenuation of the own-voice component in output signal SO as compared to the own-voice component in input signal SI, e.g., in the unprocessed input signal SI. This may be achieved, for example, by providing output signal SO based on the unprocessed input signal SI, e.g., at second path P2 illustrated in FIG. 8, which may also be referred to as a transparency of input signal SI in output signal SO, and additionally activating ANC. This may also be achieved, e.g., by determining the own-voice ANC strength OVA such that the own-voice component in direct sound is downgraded relative to the own-voice component in input signal SI. Determining the own-voice ANC strength OVA in such a manner may comprise evaluating one or more signal properties SI of input signal SI, which may be provided by signal estimator 417.

To illustrate, effectively attenuating the own-voice component in output signal SO relative to the own-voice component as represented in input signal SI may be employed to provide for an enhanced compensation, or over-compensation, of the missing Lombard effect. E.g., when user 131 is confronted with such an enhanced compensation, a desired attentiveness of the user with regard to his own voice volume being too soft may be increased or sped up so that user 131 is more likely to faster take action in raising his voice to an appropriate level. In particular, users with a normal or unimpaired hearing may not always have a high enough incentive to take action in raising their own-voice level even when confronted with the natural acoustic surroundings, e.g., due to a lack of understanding and/or missing awareness of hearing problems under the assumption that their own voice may still be perceivable enough to others. Those users may thus particularly profit from such an enhanced compensation.

FIG. 10 illustrates an exemplary configuration of a neural network (NN) 605, e.g., a DNN. Neural network 605 has an input 601 for receiving input audio signal SI. Neural network 605 has multiple outputs 606, 607, 608 for providing audio signals SSP, SOV, SRE separated from input signal SI.

First output 606 is configured to provide for separated speech signal SSP, when contained in input signal SI. E.g., separated speech signal SSP may be representative of general speech contained in input signal SI, which may include speech from multiple speakers and/or speech from the user in the form of the user's own-voice. Second output 607 is configured to provide for own-voice detection signal OVD in the form of own-voice speech signal SOV representing a speech audio signal separated from input signal SI. Third output 608 is configured to provide for residual signal SRE, which may be representative of background noise.

Neural network 605 comprises an encoder 611 for conditioning input signal SI so that one or more speech signals can be separated therefrom. The conditioned signal is then input into a speech separator 612 performing the separation in the one or more signals representative of speech. The separated signal is then converted into an audio signal by a decoder 613 so as to provide separated speech signal SSP at first output 606.

The separated signal is further input into own voice embedding 306 so that a separation of the user's own-voice can be performed by a subsequent own-voice separator 615. The separated own-voice signal is then converted into an audio signal by a decoder 616 so as to provide own-voice speech signal SOV at second output 607. Own-voice speech signal SOV represents own-voice detection signal OVD. In particular, when own-voice speech signal SOV is a blank signal or below a predetermined signal level, the own-voice content may be regarded as undetected in audio signal SI. When own-voice speech signal SOV represents an audio signal, e.g., above the predetermined signal level, the own-voice content may be regarded as detected.

The separated signal is further input into a residual signal separator 618 which can provide for the remainder of input signal SI after speech signal SSP has been separated therefrom by speech separator 612. The separated residual signal is then converted into an audio signal by a decoder 619 so as to provide residual speech signal SRE at third output 608.

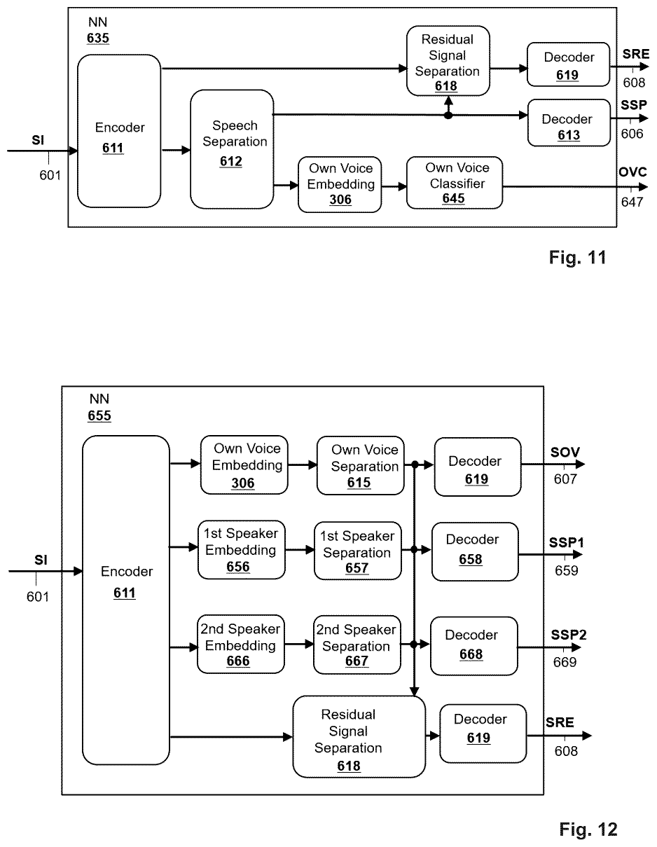

FIG. 11 illustrates another exemplary configuration of a neural network (NN) 635, e.g., a DNN. Neural network 635 has outputs 606, 608 for providing audio signals SSP, SRE separated from input signal SI. Neural network 635 has a further output 647 for providing a classification signal OVC representative of a likelihood whether the own-voice component is contained in input signal SI or not.

Neural network 635 comprises an own-voice classifier 645. Own-voice classifier 645 is provided subsequent to own voice embedding 306 so is to provide for the classification of whether the signal separated by speech separator 612 included the own-voice component or not. The classification result is then represented by own-voice classification signal OVC, which may indicate a likelihood of the own-voice component contained in input signal SI. When compared to NN 605 illustrated in FIG. 9, own-voice classifier 645 is provided in place of own-voice separator 615 and decoder 616. Own-voice classification signal OVC thus represents own-voice detection signal OVD. In particular, when own-voice classification signal OVC indicates that the own-voice component is contained in input signal SI with a likelihood above a threshold value, the own-voice content may be regarded as detected.

FIG. 12 illustrates another exemplary configuration of a neural network (NN) 655, e.g., a DNN. Neural network 635 has outputs 607, 608 for providing audio signals SOV, SRE separated from input signal SI. Neural network 655 has further outputs 659, 669 for providing audio signals SSP1, SSP2 separated from input signal SI. Audio signals SSP1, SSP2 represent speech signals of individual speakers different from the user. In particular, audio signal SSP1 represents speech of a first speaker, and audio signal SSP2 represents speech of a second speaker. The speech signals SSP separated by neural network 655 thus comprise speech signals SSP1, SSP2.

For the purpose of separating speech signal SSP1 of the first speaker from audio signal SI, a first speaker embedding 656 is implemented in neural network 655. For the purpose of separating speech signal SSP2 of the second speaker from audio signal SI, a second speaker embedding 666 is implemented in neural network 655. First and second speaker embeddings 656, 666 may be representative of unique voice characteristics of the respective speaker. E.g., embeddings 656, 666 may be provided corresponding to own-voice embedding 306, as described above in conjunction with FIG. 4. A signal representative of the speech of the respective speaker can then be separated by a respective speech separator 657, 667. The signal representative of the respective speech can then be converted in an audio signal by a decoder 658, 668 which can output speech signals SSP1, SSP2.

Any of exemplary neural networks 605, 635, 655 may be implemented in speech enhancement algorithms 301, 401, 501, as described in conjunction with FIGS. 4, 5, and 8, e.g., in place of neural network 305.

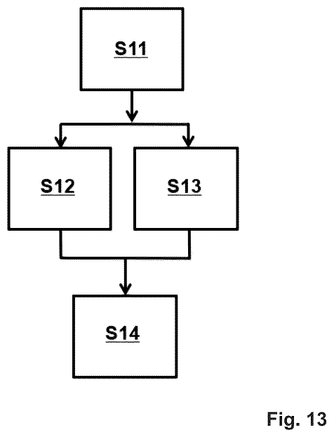

FIG. 13 illustrates a block flow diagram for an exemplary method of processing an audio signal in a hearing device. The method may be executed, e.g., by processor 104 of hearing device 101. At operation S11, input signal SI is received from audio input unit 113. A subsequent audio signal processing performed on input signal SI to obtain output signal SO comprises operations S12, S13, S14. At S12, one or more speech signals are separated from input signal SI in a neural network. At S13, it is detected by the neural network whether the input signal comprises an own-voice component representative of a speech of the user. Operations S12, S13 may be performed subsequently and/or concurrently to one another.

Operation S14 is then performed depending on whether the own-voice component is detected in input signal SI, or not. When the own-voice component is undetected, output signal SO may be based on, e.g., include, one or more of the separated speech signals. For example, the one or more of the separated speech signals may then be enhanced in output signal SO as compared to one or more speech components contained in input signal SI corresponding to the separated speech signals before the separation. Enhancing may comprise, e.g., an amplifying of the one or more speech components and/or a reducing of noise in output signal SO. When the own-voice component is undetected, input signal SI is processed to provide for an effective attenuation of the own-voice component in output signal SO relative to one or more of the separated speech signals in output signal SO when the own-voice component is undetected.

In some examples, the effective attenuation may comprise providing an enhancement of the own-voice component to a lower degree in output signal SO as compared to the enhancement of the one or more speech components when the own-voice component is undetected. In particular, a perceptibility and/or comprehensibility of the own-voice component in output signal SO may be reduced relative to the one or more speech components in output signal SO when the own-voice component is undetected and/or the perceptibility and/or comprehensibility of the own-voice component may be enhanced relative to input signal SI. In some examples, the effective attenuation may comprise maintaining the own-voice component in output signal SO relative to the own-voice component in input signal SI. Maintaining may comprise, e.g., a maintaining a signal level of the own voice component and/or an amount of noise in output signal SO relative to input signal SI. In particular, a perceptibility and/or comprehensibility of the own-voice component in output signal SO may thus be kept equal relative to input signal SI. For example, the own-voice component may be maintained by providing output signal SO based on unprocessed input signal SI. In some examples, the effective attenuation may comprise downgrading the own-voice component in output signal SO relative to the own-voice component in input signal SI. In particular, a perceptibility and/or comprehensibility of the own-voice component in output signal SO may thus be reduced relative to input signal SI. Downgrading may comprise, e.g., activating and/or increasing an active noise cancelling (ANC) in output signal SO. For example, the own-voice component may be downgraded to provide for a lower perceptibility and/or comprehensibility than in a transparency of direct sound and/or the unprocessed input signal SI.

While the principles of the disclosure have been described above in connection with specific devices, systems and methods, it is to be clearly understood that this description is made only by way of example and not as limitation on the scope of the invention. The above described embodiments are intended to illustrate the principles of the invention, but not to limit the scope of the invention. Various other embodiments and modifications to those embodiments may be made by those skilled in the art without departing from the scope of the present invention that is solely defined by the claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A method of audio processing in a hearing device to provide for speech enhancement, the hearing device configured to be worn at an ear of a user, the method comprising:
receiving an input signal from an audio input unit; and
processing the input signal so as to obtain an output signal for an audio output unit configured to output the output signal, wherein the processing comprises
separating one or more speech signals from the input signal in a neural network, wherein the output signal is based on one or more of the separated speech signals,
characterized by detecting, by the neural network, whether the input signal comprises an own-voice component representative of a speech of the user, wherein, when the own-voice component is detected, the input signal is processed so as to provide for an effective attenuation of the own-voice component in the output signal relative to one or more of the separated speech signals in the output signal when the own-voice component is undetected.

2. The method of claim 1, wherein the own-voice component is detected by the neural network by separating the own-voice component from the input audio signal so as to provide at least one separated speech signal representative of the own-voice component.

3. The method of claim 1, further comprising:
providing the neural network with an embedding derived from a speech sample of the user representative of the user's own-voice.

4. The method of claim 1, wherein said providing for the effective attenuation comprises one or more of:
reducing, when the own-voice component is detected, an amplification of the own-voice component in the output signal relative to an amplification of one or more separated speech signals in the output signal when the own-voice component is undetected; and/or
increasing, when the own-voice component is detected, noise in the output signal as compared to when the own-voice component is undetected; and/or
providing, when the own-voice component is detected, the output signal based in the input signal, wherein the one or more separated speech signals are excluded from the output signal; or
activating and/or increasing, when the own-voice component is detected, an active noise cancelling in the output signal.

5. The method of claim 1, further comprising:
determining a speech enhancement gain representative of a gain to be applied on one or more of the separated speech signals when the own-voice component is undetected; and
determining an own-voice gain representative of a gain to be applied on the own-voice component when the own-voice component is detected.

6. The method of claim 5, wherein the own-voice gain is determined based on one or more of:
the speech enhancement gain;
one or more properties the own-voice component; or
one or more properties of the input signal.

7. The method of claim 5, wherein, when the speech enhancement gain is determined to be increased, the own-voice gain is determined to be decreased.

8. The method of claim 1, wherein the audio signal processing comprises:
providing a denoised signal based on one or more of the separated speech signals;
providing a noisy signal representative of a signal in which noise contained in the input audio signal is preserved to a larger extent than in the denoised signal,
wherein, at least when the own-voice component is undetected, the denoised signal is included in the output signal, and, at least when the own-voice component is detected, the noisy signal is included in the output signal.

9. The method of claim 8, wherein the denoised signal and the noisy signal are mixed in accordance with a mixing ratio defining a ratio of the denoised signal relative to the noisy signal in the output signal, wherein the method further comprises:
determining a speech enhancement mixing ratio representative of the mixing ratio to be applied when the own-voice component is undetected; and
determining an own-voice mixing ratio representative of the mixing ratio to be applied when the own-voice component is detected.

10. The method of claim 9, wherein the own-voice mixing ratio is determined based on one or more of
the speech enhancement mixing ratio;
one or more properties of the own-voice component: or
one or more properties of the input signal.

11. The method of claim 9, wherein, when the speech enhancement mixing ratio is determined to be increased, the own-voice mixing ratio is determined to be decreased.

12. The method of claim 8, wherein the denoised signal is provided at a first signal path comprising the neural network, and the noisy signal is provided at a second signal path bypassing the first signal path, wherein the input signal is input into the first and second signal path.

13. The method of claim 8, wherein the noisy signal is based on a residual signal output by the neural network, the residual signal representative of an audio signal from which the one or more speech signals are separated by the neural network.

14. The method of claim 1, wherein, when the own-voice component is detected, the own-voice component is effectively attenuated in the output signal relative to the own-voice component contained in an unprocessed input signal.

15. A hearing device configured to be worn at an ear of a user, the hearing device comprising:
an audio input unit for obtaining an input signal;
a processor for audio signal processing of the input signal to obtain an output signal; and
an audio output unit for outputting the output signal so as to stimulate the user's hearing,
characterized in that the processor is configured to perform the method of claim 1.
